(19) United States
(12) Patent Application Publication
(10) Pub. No.: US 2011/0143330 A1
(43) Pub. Date: Jun. 16, 2011

(54) COMBINATION DRY ERASE BOARD/PROJECTION SCREEN

(76) Inventors: Keiko Shimada, Yamagata (JP); Masami Miura, Yamagata (JP); Hidetoshi Abe, Yamagata (JP); Mamoru Kanno, Yamagata (JP)

(21) Appl. No.: 13/059,993

(22) PCT Filed: Aug. 21, 2009
(86) PCT No.: PCT/US2009/054632

§ 371 Date: Feb. 21, 2011

(30) Foreign Application Priority Data
Aug. 22, 2008 (JP) 2008-214530
May 20, 2009 (JP) 2009-122353

(51) Int. Cl. B43L 1/00

(52) U.S. Cl. 434/408

(57) ABSTRACT

A communication article comprising a face layer on the front side of said article, said face layer having structured front surface and a base layer, wherein the face layer has a fluorine content of 0.02 mass % to 0.1 mass % in a solid basis. Preferred embodiments further comprise a buffer layer disposed between the face layer and base layer.

### FIELD OF INVENTION

The present application relates to a communication article which can serve both as a dry erase writing board, e.g., a white or colored writing board such as a whiteboard, and as a reflection type screen for a projector.

### BACKGROUND

Office environments are often equipped with both a writing board such as a chalk or dry erase board and a projector screen. Businesses are often changing their facilities to accommodate changes in personal and business needs. For instance, rooms which were once personal space are often redesigned to provide conference rooms. It is desirable to provide a single article which can meet the need for a writing board and a projection screen.

Dry erase boards have been used as a writing surface for years because of their convenience and versatility. The boards provide a means for expression which eliminates the mess and trouble of a chalk board. These boards however are not useful as projection surfaces because of the glare associated with the writing surface. If an ordinary dry erase board is used as the projection surface, the typical resultant glare and reflection of the projection bulb commonly leads to eye strain and fatigue to the viewers.

Some previously known dry erase boards include the following.

WO01/32440 (Tatsuki et al.) describes a combination dry erase board/reflective projection screen that comprises a substrate and a coating of UV cured resin comprising acrylic monomers formed on the substrate, wherein the substrate is embossed from the front side or the back side. The coating does not include fluorine.

JP11-254885A (Nakamura et al.) describes a sheet for a whiteboard which comprises a film laminate comprising a white substrate and a fluorine film with an activated hydrophilicity or polarity by light irradiation, wherein the surface of the fluorine film has an emboss with an embossing plate.

It is desirable to have a multifunctional article which can durably act effectively as both a dry erase board and a projection screen upon which images can be projected image with high brightness, high contrast, and wide viewing angle.

### SUMMARY OF INVENTION

The present application provides communication articles that can perform both as dry erase boards and as projection screens. Articles of the invention exhibit superior writeability and erasability, making them useful as dry erase boards, and also exhibit good anti-glare properties, making them useful as projection screens. In addition, articles of the invention can exhibit good durability, i.e., retaining desired writeability, erasability, and anti-glare characteristics while being resistant to formation of cracks and scratching.

Briefly summarizing, articles of the invention comprise a face layer, optional buffer layer, base layer, and optional adhesive layer. The face layer has a structured front surface and is made using a resin comprising UV-curable fluorinated oligomer and/or comprises UV-curable fluorinated monomer having a fluorine content of from about 0.02 mass % to 0.1 mass % in a solid basis. The buffer layer, if present, is a heat stable film, e.g., a highly-crosslinked forming resin such as one comprising carboxylic group(s) and amino group(s), which imparts greater heat stability to the structured surface of the face layer so it retains structured surface character even when the article is heated, for example, by the light of a projector. As a result, articles of the invention surprisingly retain their anti-glare properties.

### BRIEF DESCRIPTION OF DRAWING

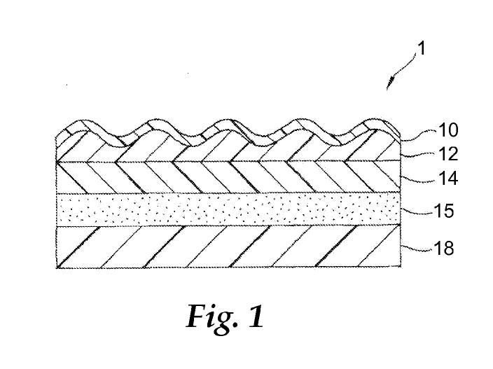

The invention will be explained with referenced to FIG. 1 which is a cross sectional view of an illustrative article of the invention. FIG. 1 is not to scale.

### DETAILED DESCRIPTION OF ILLUSTRATIVE EMBODIMENTS

An illustrative embodiment of the invention is shown in FIG. 1 wherein article 1 comprises face layer 10, optional buffer layer 12, base layer 14, optional adhesive layer 16, and optional liner 18.

### Face Layer

The face layer is on the front surface of article. In use in accordance with the invention, this surface can be written on with dry erase markers and/or used as a display surface upon which images may be projected. The face layer has a structured front surface as described below.

Typically the face layer is made from curable resin composition. In preferred embodiments, this is a resin composition comprising one or more UV-curable fluorinated oligomers and/or one or more UV-curable fluorinated monomers. Depending upon the embodiment, the resin composition may consist essentially of a UV-curable fluorinated oligomer; a UV-curable fluorinated monomer; or a mixture of a UV-curable fluorinated oligomer and a UV-curable fluorinated monomer. Alternatively, the resin may consist of a mixture of a UV-curable fluorinated oligomer and a UV-curable non-fluorinated monomer or a mixture of a UV-curable non-fluorinated oligomer and a UV-curable fluorinated monomer. In both cases, the resin may further include known light curable monomers, known polymers and/or known photopolymerization initiators.

By “fluorinated oligomer” (or “fluorinated monomer”) is meant an oligomer (or monomer) comprising one or more fluoroalkyl groups, for example, a fluoroalkyl group which includes a straight or branched C₁ to C₁₂ alkyl group having at least one hydrogen substituted with a fluorine atom. Illustrative examples include, for example, 2,2,3,3,3-pentafluoropropyl, 2-(perfluorohexyl)ethyl, 2-(perfluorooctyl)ethyl, 2-(perfluorodecyl)ethyl, 6-(perfluoroethyl)hexyl, 6-(perfluorobutyl)hexyl, 6-(perfluorohexyl)hexyl, 6-(perfluorooctyl)hexyl, 2,2,3,4,4,4-hexafluorobutanol, 2,2,3,3-teterafluoropropyl, 2-(perfluoro-3-methylbutyl)ethyl, 2-(perfluoro-5-methylhexyl)ethyl, 2-(perfluoro-7-methyloctyl)ethyl, 6-(perfluoro-1-methylethyl)hexyl, 2-(perfluoro-3-methylbutyl)hexyl, 6-(perfluoro-5-methylhexyl)hexyl, and 6-(perfluoro-7-methyloctyl)hexyl.

Typically the face layer comprises from about 0.02 to about 0.1 mass % of fluorine. It has been found that face layers having that range of fluorine content exhibit good writeability and erasability to dry erase markers as well as resistance to cracking. In typical embodiments, the amount of the fluorine (on final solids basis) can be from about 0.02 to about 0.1 mass %, preferably from about 0.02 to about 0.09 mass %, more preferably from about 0.03 to about 0.09 mass %, or most preferably from about 0.033 to about 0.084 mass %. If the face layer contains an excessive fluorine content, there will be a tendency for ink shedding and reduced writeability performance. If the face layer contains insufficient fluorine content, there will be a tendency for eras ability performance to be degraded.

Illustrative examples of suitable UV-curable fluorinated oligomers for use herein include oligomers having a weight average molecular weight of from about 400 to about 10,000. Examples of such oligomers include, for example, acrylic oligomers (e.g., epoxy acrylate, polyester acrylate, or polyurethane acrylate) or acrylic urethane oligomers (e.g., polyether urethane acrylate). The proportion of the oligomer in the resin composition is selected dependent upon such factors as the materials used, desired face layer properties, cost, etc. For example, in some embodiments it can be from about 1 to about 80 mass % with respect to the total resin amount in solids.

Illustrative examples of suitable UV-curable fluorinated monomers include 2-ethylhexyl acrylate, 2-hydroxyethyl acrylate, 2-hydroxypropyl acrylate, 2-hydroxyethyl acryloyl phosphate, 1,3-butanedioldiacrylate, 1,4-butanedioldiacrylate, 1,6-hexandioldiacrylate, diethyleneglycoldiacrylate, tripropyleneglycol diacrylate, neopentylglycol diacrylate, polyethyleneglycol 400 diacrylate, hydroxypivalic acid esterneopentylglycoldiacrylate, trimethylol propane triacrylate, pentaerythritol triacrylate, dipentaerythritol hexacrylate, isophorone diisocyanate (IPDI) and acroyl morpholine. The proportion of the monomer in the resin composition is not limited, but can be selected accordingly intended to be the desired fluorine amount or to be able to form the face layer. For example, in some embodiments it can be from about 1 to about 80 mass % of the whole resin on solids basis.

When resin compositions containing both one or more UV-curable fluorinated oligomers and one or more UV-curable fluorinated monomers as described herein, their total proportion can range from about 1 mass % to about 80 mass % of the whole resin in solids.

UV-curable non-fluorinated oligomers useful herein include those having a weight average molecular weight of from about 400 to about 10,000. Illustrative examples include acrylic oligomers (e.g., epoxy acrylate, polyester acrylate or polyurethane acrylate) and acrylic urethane oligomers (e.g., polyether urethane acrylate). The amount of the non-fluorinated oligomers in the resin composition is typically selected to yield the desired proportion of fluorine in the resultant face layer. For example, it can be from about 5 to about 80 mass % of the whole resin in solids.

UV-curable non-fluorinated monomer useful herein include, for example, such monomers as one or more of 2-ethylhexyl acrylate, 2-hydroxyethyl acrylate, 2-hydroxypropyl acrylate, 2-hydroxyethyl acryloyl phosphate, 1,3-butanedioldiacrylate, 1,4-butanedioldiacrylate, 1,6-hexandioldiacrylate, diethyleneglycoldiacrylate, tripropyleneglycol diacrylate, neopentylglycol diacrylate, polyethyleneglycol 400 diacrylate, hydroxypivalic acid esterneopentylglycoldiacrylate, trimethylol propane triacrylate, penta erythritol triacrylate, dipeneta erythritol hexacrylate, isophorone diisocyanate (IPDI) and acroyl morpholine. The amount of the monomer in the resin is selected according to the desired fluorine amount in the face layer as well as desired face layer properties, cost, etc. Examples of the amount can be about 5 to about 50 mass % of the whole resin in solids.

Typically, the resin composition used to make the face layer will include one or more photopolymerization intiator(s). Illustrative examples include known initiators such as 1-hydroxycyclohexylphenylketone (IRUGACURE® 184 from Ciba Japan K.K.), 2,2-dimethoxy-2-phenyl acetophenone (IRUGACURE® 651 from Ciba Japan K.K.), 2-hydroxy-2-methyl-1-phenylpropanel-one (DAROCUR® 1173 from Ciba Japan K.K.), 2-methyl1-[4-(methylthio)phenyl]-2-morpholino propane-1-one (IRUGACURE® 907 from Ciba Japan K.K.), 2-benzyl-2-dimethylamino-1-(4-morpholino phenyl)-butane-1-one, 2-chlorothioxanthone, 2,4-dimethylthioxanthone, 2,4-diisopropylthioxanthone, isopropylthioxanthone, 2,4,6-trimethylbenzoylphosphonoxide or bis(2,6-dimethoxybenzoyl)-2,4,4-trimethylpentylphosphonoxide. Those initiators can be used alone or in combination with other initiators.

Typically the amount of the photopolymerization initiator can be about 0.5 to about 20 mass % or about 1 to about 10 mass % of the whole resin in solids, though depending upon the materials selected amounts outside these ranges may be useful,

Illustrative examples of commercial materials suitable for use in resin compositions for the face layer includes, for example, compositions comprising of one or more of the following:
SEIKABEAM™ P-1301 (from Dainichiseika Color & Chemicals Mfg. Co., Ltd., a non-fluorinated resin composition containing polyether urethane acrylate, acrylic monomer, and photopolymerization initiator, 80% solids);
SN-5X-7624 (from San Nopco Limited, a non-fluorinated resin composition comprising polyether urethane acrylate, photopolymerizaion monomer, polyester urethane, and photopolymerization initiator, 40% solids);
ADEKA OPTOMER™ KR566 (from Adeca Corporation, a non-flourinated resin composition containing acrylic monomer, and photopolymerization initiator, 80% solids); and
DEFENSA™ FH-800ME (from DIC Corporation, a fluorinated resin composition containing a mixture of acrylic monomer and photopolymerization initiator, 90% solids).

In some embodiments, the amount of each resin selected might be, for example, as follow: for resins selected from SEIKABEAM™ P-1301, SN-5X-7624, and ADEKA OPTOMER™ KR566, it might be about 100 mass parts per 100 total mass parts; in the case of DEFENSA™ FH-800ME it might be about 25 to about 100 mass parts with respect to 100 mass parts.

The face layer has a structured front surface to reduce its specular gloss, thereby reducing glare. The 60° specular gloss is preferably about 30 or less, typically between about 10 and about 30. Dry erase boards exhibiting this range of 60° specular gloss typically do not generate significant glare.

The pattern of the structured surface can be random or regular. Typically, the front surface of the face layer will have an arithmetic average roughness (i.e., Rₐ) (measured according to JIS B 0601-2001) between about 1 μm and about 5 μm, an adjacent protrusions (i.e., Sₘ) (measured according to JIS B 0601-1994) between about 200 μm and about 800 μm, and a maximum roughness depth (i.e., Rₜ) (measured according to JIS B 0601-2001) between about 1 μm and about 30 μm.

The face layer can be prepared by the ordinary method such as coating, polymerizing and drying a polymer solution on the surface of the buffer layer. For example, one or more UV-curable flourinated oligomer(s) and/or one or more UV-curable fluorinated monomer(s) and, if necessary, photoinitiator and/or photopolymerization initiator and non-flourinated oligomer or monomer, if used, are mixed in a solvent to yield a curable polymer solution, then the solution is coated, polymerized, and embossed to furnish the face layer.

The polymer solution, for example, can be coated by the known coating method such as bar coating, e.g., wire bar coating; knife coating; or gravure coating. The curing of the polymer solution can be made with a UV oven. An illustrative embossing method is explained below.

The embossing can be available from the known method. In general, the sheet laminate of the face layer and the buffer layer is passed between an embossing roll and a back up roll (with the front surface of the face layer toward the embossing roll), and the surface pattern of the embossing roll is transferred to the surface of the face layer. The embossing is preferably conducted with heating. The appropriate temperature will be dependent in part upon such factors as materials, processing speed, equipment, pressure, etc. and will typically be between about 50° C. and about 270° C. though temperatures outside this range might be used in accordance with the invention. The roll pressure of the embossing will be dependent in part upon such factors as materials, processing speed, equipment, pressure, etc. and will typically be between about 0.4 and about 1.0 MPa though pressures outside this range might be used in accordance with the invention.

The back up roll may be made of the same material or different material as of the embossing roll. A soft roll which can be prepared by wrapping with a flexible material such as rubber or cotton around the metallic roll can be also used. The other embossing condition is according to the ordinary method in embossing the surface of the protection layer of the ordinary sheets.

As will be understood by those skilled in the art, the structured surface of the face layer may be formed other techniques, e.g., such as curing the layer's resin composition in a mold having the desired structured surface.

The thickness of the face layer will typically be from about 2 μm to about 20 μm, and sometimes preferably from about 2 μm to about 6 μm. In some embodiments comprising a buffer layer, the preferred thickness may be from about 2 μm to about 4 μm.

The surface structures on the front surface of the face layer may be extend into only the face layer or may extend deeper in to the article, reaching the buffer layer, if any, or in some instances, even into the base layer.

Typically it is preferred that the face layer be clear.

### Buffer Layer

In preferred embodiments, articles of the invention comprise a buffer layer between the face layer and the base layer. The buffer layer provides support to the face layer, imparting improved retention of the face layer's structured surface character, e.g., as the article is heated when used as a projection screen.

In a typical embodiment, the buffer layer comprises a highly cross-linked polymer mixture of a carboxylic group containing acid polymer and an amino group containing base polymer. Located on the back side of the face layer, the buffer layer serves to impart greater dimensional stability to the face layer such that it does not tend top flatten or flow when heated and thereby degrade its anti-glare performance. Therefore the anti-glare characteristics of the article are maintained if the writing sheet is used as a screen and is exposed to heat by a projector.

The buffer layer comprises a film-forming resin including an amino group-containing (meth)acrylic polymer, a carboxylic group-containing (meth)acrylic polymer and a cross-linker. The term “(meth)acrylic” means acrylic or methacrylic in the present specification.

One method for obtaining the amino group-containing (meth)acrylic polymer includes polymerizing a monoethylenic unsaturated monomer and an unsaturated monomer containing an amino group. One method for obtaining the (meth)acrylic polymer with a carboxyl group is to copolymerize a monoethylenic unsaturated monomer and an unsaturated monomer containing a carboxyl group.

In one embodiment the copolymerization is carried out by radical polymerization. Any known polymerization method can be used for this purpose, such as solution polymerization, suspension polymerization, emulsion polymerization, or block polymerization.

Illustrative examples of photoinitiators that can be used include benzoyl peroxide, lauroyl peroxide, bis(4-tert-butylcyclohexyl)peroxydicarbonate, or another such organic peroxide, or 2,2′azobisisobutyronitrile, 2,2′-azobis-2-methylbutyronitrile, 4,4′-azobis-4-cyanovalerianic acid, dimethyl 2,2′-azobis(2-methylpropionate), azobis-2,4-dimethylvaleronitrile (AVN), and other azo-based polymerization initiators. The amount of initiator used is normally between 0.05 and 5 mass parts for 100 mass parts of the monomer mixture though amounts outside this range might be used. The type and amount of photoinitiator used will be dependent in part upon the materials used, desired properties, desired cure properties, cost, etc.

The monoethylenic unsaturated monomer is a main component of the polymer, and is generally expressed by the formula CH₂═CR¹COOR (where R¹ is a hydrogen or a methyl group, and R is a linear, cyclic, or branched alkyl group, or a phenyl group, alkoxyalkyl group, phenoxyalkyl group, or cyclic ether group). Examples of these monomers include methyl (meth)acrylate, ethyl (meth)acrylate, n-butyl (meth)acrylate, isoamyl (meth)acrylate, n-hexyl (meth)acrylate, 2-ethylhexyl (meth)acrylate, isooctyl (meth)acrylate, isononyl (meth)acrylate, decyl (meth)acrylate, dodecyl (meth)acrylate, cyclohexyl (meth)acrylate and other alkyl (meth)acrylates. Also, phenoxyethyl (meth)acrylate and other such phenoxyalkyl (meth)acrylates, methoxypropyl (meth)acrylate, 2-methoxybutyl (meth)acrylate, and other such alkoxyalkyl (meth)acrylates, glycidyl (meth)acrylate, tetrahydrofurfuryl (meth)acrylate, and other such (meth)acrylates containing a cyclic ether, and the like can be used. Depending on the objective, one, or two or more monoethylenic unsaturated monomers can be used in order to achieve the desired properties.

Examples of unsaturated monomers that contain an amino group include N,N-dimethylaminoethyl acrylate, N,N-dimethylaminoethyl methacrylate, and other such dialkylamino alkyl (meth)acrylates, N,N-dimethylaminopropyl acrylamide, N,N-dimethylaminopropyl methacrylamide, and other such dialkylaminoalkyl (meth)acrylamide, N,N-dimethylaminoethyl vinyl ether, N,N-diethylaminoethyl vinyl ether, and other such dialkylaminoalkyl vinyl ethers, as well as blends thereof. Examples of other unsaturated monomers that contain an amino group include vinyl pyridine, vinyl imidazole, and other monomers with tertiary amino groups represented by nitrogen containing vinyl monomers with heterocyclic rings, and styrene with a tertiary amino group (such as 4-(N,N-dimethylamino)-styrene, and 4-(N,N-diethylamino)-styrene and the like).

Examples of the unsaturated monomer with a carboxyl group include unsaturated monocarboxylic acids (such as acrylic acid and methacrylic acid and so forth), unsaturated dicarboxylic acids (such as maleic acid, itaconic acid, and so forth), ω-carboxypolycaprolactone monoacrylate, phthalic acid monohydroxyethyl (meth)acrylate, β-carboxyethyl acrylate, 2-(meth)acryloyloxyethyl succinic acid, and 2-(meth)acryloyloxyethyl hexahydrophthalic acid.

In one embodiment the (meth)acrylic polymer containing a carboxyl group and the (meth)acrylic polymer containing an amino group are obtained by specifically copolymerizing between 0.5 and 20 mass parts of an unsaturated monomer containing a carboxyl group or an amino group with between 80 and 99.5 mass parts of a monoethylenic unsaturated monomer as the main component.

The weight average molecular weight of one from the amino group-containing (meth)acrylic polymer and the carboxylic group-containing (meth)acrylic polymer can be, for example, about 40,000 to about 200,000, and another from them can be about 400,000 to about 1,000,000.

The weight average molecular weight of those polymers can be selected from the view of the balance of various performance of (meth)acrylic polymer formed from those polymers.

The weight average molecular weight (Mw) can be measured by GPC method (Gel Permeation Chromatography), for example, using the following equipment and materials:
Experimental apparatus: HP-1090 Series II (available from Hewlett-Packard)
Column: Plgel MIXED-Bx2 (300 mm, OD 7.5 mm, ID 5 mm; available from Agilent Technologies)
Detection: RI (refractive index)
Solvent: tetrahydrofuran
Flow rate: 1.0 mL/min
Sample concentration: 0.1 wt %
Calibration standard: polystyrene.

In the film forming polymer, the glass transition temperature (T_{g}) of one from the amino group-containing (meth)acrylic polymer and the carboxylic group-containing (meth)acrylic polymer is about 20° C. or more (sometimes referred to as the “Soft Polymer”) and the T_{g} of the other is about 0° C. or less (sometimes referred to as the “Hard Polymer”, “Soft” and “Hard” being relative terms here).

For example, T_{g} of the amino group-containing (meth)acrylic polymer can be about 20° C. or more, about 40° C. or more, or about 60° C. or more, and T_{g} of the carboxylic group-containing (meth)acrylic polymer can be about 0° C. or less, about −20° C. or less, or about −40° C. or less.

The polymer having higher T_{g} imparts high tensile strength to the resultant buffer layer and the polymer having lower T_{g} imparts desired elongation at low temperature to the resultant buffer layer. Therefore it is obtained that the film has strength with a good balance of high tensile strength and elongation.

The polymer having a T_{g} of about 20° C. or more can be prepared by co-polymerizing a monoethylenic unsaturated monomer, the homopolymer of which has a T_{g} of about 20° C. or more. For instance, an amino group-containing (meth)acrylic polymer having a T_{g} of about 20° C. or more can be prepared by co-polymerizing, for example, methylmethacrylate or n-butylmethacrylate.

The polymer having a T_{g} of about 0° C. or less can be prepared by co-polymerizing a monoethylenic unsaturated monomer, the homopolymer of which has a T_{g} of about 0° C. or less. For instance, a carboxyl group-containing (meth)acrylic polymer having a T_{g} of about 0° C. or less can be prepared by co-polymerizing, for example, ethylacrylate, n-butylacrylate or 2-ethylhexylacrylate.

The T_{g} of the amino group-containing (meth)acrylic polymer and the carboxyl group-containing (meth)acrylic polymer is determined by the FOX equation (i.e., where the T_{g} of a resultant polymer can be calculated from the fractions and respect T_{g} of the monomers as follows:

1/T_{g}=X¹/(T_{g}¹+273.15)+X²/(T_{g}²+273.15)⁺ . . . +Xⁿ/(T_{g}ⁿ+273.15)

wherein:
T_{g}¹ is the glass transition point in ° C. of component 1,
T_{g}² is the glass transition point in ° C. of component 2, and so forth, and
X¹ is the weight fraction of component 1 added during the polymerization,
X² is the weight fraction of component 2 added during the polymerization, and so forth (X¹+X²+ . . . +Xⁿ=1)).

Illustrative examples of cross-linkers that can be used herein to react with the carboxylic functionality bisamide based cross-linkers (such as 1,1′-isophthaloyl-bis(2-methylaziridine)), aziridine based cross-linkers (such as CHEMITITE™ PZ33 available from Nippon Shokubai, or NEOCRYL™ CX-100 available from Avecia), carbodiimide based cross-linkers (such as CARBODILITE™ V-03, V-05, or V-07 available from Nisshinbo), epoxy based cross-linkers (such as E-AX, E-5XM, or E5C, available from Soken Chemical and Engineering). The amount of the cross-linker can be about 0.01 to about 10 mass parts, or about 1 to about 10 mass parts with respect to 100 mass parts of the carboxyl group-containing (meth)acrylic polymer.

The amount above may be effective for obtaining the highly cross-linked and heat stable buffer film.

The buffer layer can be prepared by blending at least one type of the carboxy group containing (meth)acrylic polymer, at least one type of the amino group containing (meth)acrylic polymer, at least one type of the polyacrylate, and a cross-linker with a known method, and then forming the film with a standard film forming method. More specifically, a film can be prepared, for example, by mixing solutions of these polymers, adding toluene, ethyl acetate, or another such volatile solvent if necessary to adjust the viscosity, coating the release surface of a peeling liner, and removing the volatile solvents of the polymer solutions by drying. Any ordinary coater can be used for this coating apparatus, such as a bar coater, knife coater, roll coater, or die coater. This film can also be formed by melt extrusion molding.

Forming the buffer layer, a film having desired tensile strength and elongation can be obtained by varying the ratios in which the (meth)acrylic polymers are blended. More specifically, in some embodiments the blend ratio (mass ratio) of the (meth)acrylic polymer with a T_{g} of about 20° C. or more and the polymer with a T_{g} of about 0° C. or less is between about 10:90 and about 90:10; in other embodiments it is between about 20:80 and about 90:10; in another embodiment it is between about 30:70 and about 90:10; and in yet another embodiment it is between about 50:50 and about 90:10; and in still other embodiments is between about 50:50 and about 70:30.

The equivalent amount of the carboxyl group containing monomer (C) in the carboxylic (meth) acrylic polymer can be one or more with respect to that of the amino group containing monomer (A) in the amino (meth) acrylic polymer. In this case, that is the equivalent amount ratio (A)/(C) is one or more, an emboss retention ratio on heating tends to be more improved.

The thickness of the buffer layer is not limited to, but for example, can be from about 11 μm to about 100 μm, from about 11 μm to about 50 μm, or from about 13 μm to about 30 μm.

Typically it is preferred that the buffer layer be clear.

### Base Layer

Underlying the face layer, and buffer layer, if any, is the base layer. The base layer may be a single ply or multiple ply layer as desired.

In many embodiments it will be a film comprising one or more thermoplastic resins. Illustrative examples include vinyl chlorides, vinyl chloride-vinyl acetates, acrylic polymers, polyesters such as PET or PET-G, and cellulose polymers. Other polymeric or non-polymeric materials may be used if desired.

The color of the base layer may be selected as desired. Often white is preferred such that the resultant communication article will be white.

The thickness of the base is not limited to but, can be about 50 μm to about 300 μm.

### Adhesive Layer

Articles of the invention may optionally comprise an adhesive layer on the back side thereof.

Selection of a suitable adhesive will be dependent upon, inter alia, the environment in which the article will be used. Suitable adhesives can be readily selected by those skilled in the art. For instance, many suitable known pressure sensitive adhesives (PSAs) are known. The adhesive is not limited to, but includes, for example, an acrylic adhesive, a polyester adhesive, a rubber adhesive, a silicone adhesive or a polyurethane adhesive.

The adhesive layer can be formed, for example, by preparing an adhesive liner having a coated adhesive on a flat surface of the liner and dry-laminating the adhesive liner and the base layer.

The thickness of the adhesive layer is not limited to, but for example, can be about 5 μm to about 200 μm.

The writing sheet may further comprise a liner on the outer side of it. The liner is not limited to specific members and includes a liner usually used in adhesive tape area. The liner includes, for example, papers; plastics such as polyethylene, polypropylene, polyester or cellulose acetate; or papers coated by such plastics, or laminated with these plastics. These liners can be used without pretreatment, or with pretreatment by silicone or the like to improve peeling property.

The writing sheet can be prepared by the ordinary method. The following can be an example.

Firstly, to the base layer, the clear film layer is laminated by the method mentioned above, then the face layer is laminated to obtain a writing sheet precursor. Subsequently, embossing is made to the writing sheet precursor from the side of the face layer. To a liner a polymer solution is coated and dried to give an adhesive layer. The obtained adhesive layer is laminated on the base layer of the writing sheet precursor having the unevenness by embossing to give the writing sheet.

The total thickness of the writing sheet is not limited to, can be, for example, from about 80 μm to about 500 μm.

The writing sheet has both abilities as a writing board typified by a whiteboard and a screen for various kinds of projectors. By being attached to the whiteboard base, it can be used for movable writing board/screen. By being attached to the wall, it can be used for a wall paper. In the latter case, meeting room wall can be directly a writing board/screen, thereby it may contribute to space reduction.

The following abbreviations are used in this specification.

MMA: methyl methacrylate

BMA: butyl methacrylate

DMAEMA: dimethylaminoethylmethacrylate

BA: butylacrylate

AA: acrylic acid

2EHA: 2-ethyl-hexyl-acrylate

VAc: vinyl acetate

AN: acrylonitrile

EtAc: ethyl acetate

MEK: methylethylketone

Mw: weight average molecular weight

DMAEMA: dimethylaminoethylmethacrylate

BMA: butyl-methacrylate

### EXAMPLES

The invention will be further explained with reference to the following illustrative examples and comparative examples.

### Test Methods

The following test methods were used.

Arithmetic Average Roughness (Rₐ): Rₐ was measured as indicated using a HANDYSURF™ Roughness Tester (from Tokyo Seimitsu Co., Ltd.).

Average Ridge Interval Between Adjacent Protrusions (Sₘ) and Maximum Roughness Depth (Rₜ): Sₘ and Rₜ were measured as indicated with a high performance 3D non-contact surface roughness measuring system (from Veeco Japan).

Writeability (Table 3): A straight line of 5 centimeters was drawn with a whiteboard marker (WBMAR-12L-B, refillable, middle-large, Black, available from Pilot Co., Ltd.) on a specimen and the condition of ink-shedding, if any, was judged by the unaided human eye. A “Circle” in Table 3 indicates that no ink-shedding was observed and a “Cross” indicates that ink-shedding was observed.

Writeability (Table 6): Grid lines were drawn on a specimen with the commercial markers listed below. The condition of ink-shedding, if any, was judged by the unaided human eye. If ink-shedding was not observed, it was ranked as “Good”; if ink-shedding was observed, it was ranked as “Poor”. The following markers were used:
Whiteboard marker, middle type (Black, Red, Blue, Green), from PILOT Co., Ltd.,
Whiteboard marker, middle type (Black, Red, Blue, Green), from PENTEL Co., Ltd.,
ASKUL original whiteboard marker (Black, Red, Blue), from ASKUL Co., Ltd.,
Whiteboard marker, middle type (Black, Red, Blue, Green), from KAUNET Co., Ltd., and
Whiteboard marker, middle type (Black, Red, Blue, Green), from Mitsubishi Pencil

Erasability (Table 3): A straight line of 5 centimeters was drawn with a whiteboard marker (WBMAR-12L-B, refillable, middle-large, Black, available from Pilot Co., Ltd.) on a specimen, then the line was wiped with a wiper part of the eraser (available from Plus Corporation) attached to Color Fastness Rubbing Tester (available from Tester Sangyo Co, Ltd.) (one lap with a vertical load of 500 grams), and the condition of ink-shedding was judged by visual. A “Circle” in Table 3 indicates no line was observed and a “Cross” indicates a line was observed.

Erasability (Table 6): After Writeability was done, the specimens were aged for 12 hours at room temperature, and the Erasability evaluated by using the indicate commercial eraser and evaluating the results with the unaided human eye. In Table 6 results were categorized as follows:
“Good” indicates that the ink was completely erased by 2 back and forth wiping,
“Fair” indicates that the ink was erased by between 3 to 4 back and forth wiping, and
“Poor” indicates that the ink was not still erased 5 or more back and forth wiping.

The erasers used for evaluation were as follows:
Board eraser, from PLUS Co., Ltd
Whiteboard eraser, “YOKUKIERU”, from KOKUYO Co., Ltd
“Axis” whiteboard eraser, from DEBIKA Co., Ltd

Crack Observation of Face Layer: A straight line of 5 centimeters was drawn with a whiteboard marker (WBMAR-12L-B, refillable, middle-large, Black, from Pilot Co., Ltd.) on a specimen, then the line was wiped with a wiper part of the eraser (from Plus Corporation) attached to Color Fastness Rubbing Tester (from Tester Sangyo Co, Ltd.) (one lap with a vertical load of 500 grams), and the condition of ink-shedding was judged by the unaided human eye. In the results, a “Circle” indicates no line was observed (meaning no crack) and a “Cross” indicates a line was observed (i.e., some ink remained due to crack).

Abrasion Resistance: The specimen prepared in the examples and comparative examples were wiped with a friction material (#0000 steel wool) attached to Color Fastness Rubbing Tester (from Tester Sangyo Co, Ltd.) (ten laps with a vertical load of 500 grams), then the condition of abrasion of the specimen was judged by the unaided human eye. In the results, a “Circle” indicates no good performance and a “Cross” indicates poor performance.

Specular Gloss: 60° specular gloss of the writing sheets obtained in the examples and the comparative examples were measured with a portable gloss meter (from Murakami-Shikisai-Gijyutsu-Kenkyusho). The result was shown in Table 3.

Specular Gloss (Post-Heating): Specimens in 30 mm×50 mm square were placed and heated with a 1400 W dryer from the vertical distance of 30 mm for 30 seconds and measured 60° specular gloss with a portable gloss meter (from Murakami-Shikisai-Gijyutsu-Kenkyusho). The result was shown in Table 3.

Specular Gloss Retention: Difference between the specular gloss value of pre-heating and post-heating was measured. The result was shown in Table 3.

“Good” represents 3 or less of the difference value,

“Fair” represents 3 to 5 of the difference value, and

“Poor” represents more than 5 of the difference value.

### Preparation of Coating Composition

Coating composition 1: 100 mass parts of SEIKABEAM™ P-1301 was added to 25 mass parts of DEFENSA™ FH-800ME then diluted with MEK by double to give a solution.

Coating compositions 2 to 6: The compositions were made in the same manner as the coating composition 1. Components of each composition were shown in Table 1.

Coating composition 7: 100 mass parts of was diluted with MEK by double to give a solution.

Coating composition 8: 100 mass parts of SN-5×−7624 was added to 25 mass parts of DEFENSA™ FH-800ME then diluted with MEK by double to give a solution.

Coating compositions 9 to 12: The compositions were made in the same manner as the coating composition 1. Components of each composition were shown in Table 1.

### Examples 1 to 4

The coating compositions 1 to 4 were each independently coated onto a white co-polyester (“PET-G”) film having a thickness of 100 μm (from Achilles Co.) with a wire bar, then cured with a UV oven (from Fusion UV Systems, Inc.) to form a 5 μm thickness of the face layer on the base layer. Subsequently, the face layer of the obtained sheet was contacted to an embossing roll and embossed with the embossing roll. An acrylic adhesive solution (butyl acrylate/acrylic acid, 90:10 mass ratio, 32% solids) was coated on a liner and dried to form the adhesive layer having 40 μm thickness, then disposed on the base side of the obtained sheet and formed the writing sheet. Rₐ, Sₘ, and Rₜ were shown in Table 2.

### Example 5

The writing sheet was prepared in the same manner as Example 1 except that the embossing was made to impart a structured surface having the Rₐ, Sₘ, and Rₜ values shown in Table 2.

### Examples 6 to 9

The writing sheet was prepared in the same manner as Example 1 except that the coating compositions 8 to 11 were used and the embossing was made to be the Rₐ, Sₘ, and Rₜ values shown in Table 2.

### Comparative Example C1

The writing sheet was prepared in the same manner as Example 1, but no embossing to impart a structured surface was made.

### Comparative Example C2

The writing sheet was prepared in the same manner as Example 1 except that the embossing was made to be the Rₐ, Sₘ, and Rₜ values shown in Table 2.

### Comparative Example C3

The writing sheet was prepared in the same manner as Example 1 except using the coating composition 5.

### Comparative Example C4

The writing sheet was prepared in the same manner as Example 1 except using the coating composition 6.

### Comparative Example C5

The writing sheet was prepared in the same manner as Example 1 except using the coating composition 7.

### Comparative Example C6

The writing sheet was prepared in the same manner as Example 1 except using the coating composition 12.

### Comparative Example C7

A 25 μm thickness of ethylene tetrafluoroethylene polymer film (from Asahi Glass Co., Ltd.) was laminated onto one side of a white PET-G film having a thickness of 100 μm (from Achilles Co.) to form a film laminate. The ethylene tetrafluoroethylene polymer film of the obtained film laminate was contacted to an embossing roll and embossed with the embossing roll. An acrylic adhesive solution (butyl acrylate/acrylic acid having 90:10 mass ratio, 32% solids) was coated on a liner and dried to form the adhesive layer having 40 μm thickness, then disposed on the white PET-G film of the obtained film laminate and formed the writing sheet. Rₐ, Sₘ, and Rₜ were shown in Table 2.

TABLE 1

| Coating composition | | | |
|---|---|---|---|
| | | Content | |
| | | (mass | fluorine |
| No. | Composition | parts) | content (mass %) |
| 1 | SEIKABEAM ™ P-1301 | 100 | 0.033 |
| | DEFENSA ™ FH-800ME | 25 | |
| 2 | SEIKABEAM ™ P-1301 | 100 | 0.041 |
| | DEFENSA ™ FH-800ME | 33 | |
| 3 | SEIKABEAM ™ P-1301 | 100 | 0.067 |
| | DEFENSA ™ FH-800ME | 67 | |
| 4 | SEIKABEAM ™ P-1301 | 100 | 0.084 |
| | DEFENSA ™ FH-800ME | 100 | |
| 5 | SEIKABEAM ™ P-1301 | 100 | 0.018 |
| | DEFENSA ™ FH-800ME | 11 | |
| 6 | SEIKABEAM ™ P-1301 | 33 | 0.140 |
| | DEFENSA ™ FH-800ME | 100 | |
| 7 | ADEKA OPTOMER ™ KR566 | 100 | 0 |
| 8 | SN-5X-7624 | 100 | 0.033 |
| | DEFENSA ™ FH-800ME | 25 | |
| 9 | SN-5X-7624 | 100 | 0.041 |
| | DEFENSA ™ FH-800ME | 33 | |
| 10 | SN-5X-7624 | 100 | 0.067 |
| | DEFENSA ™ FH-800ME | 67 | |
| 11 | SN-5X-7624 | 100 | 0.084 |
| | DEFENSA ™ FH-800ME | 100 | |
| 12 | SN-5X-7624 | 100 | 0.018 |
| | DEFENSA ™ FH-800ME | 11 | |

TABLE 2

| | Coating | | | |
|---|---|---|---|---|
| | composition | Rₐ | Sₘ | Rₜ |
| Ex. | (No.) | (μm) | (μm) | (μm) |
| 1 | 1 | 3.9 | 300 | 25 |
| 2 | 2 | 3.9 | 300 | 25 |
| 3 | 3 | 3.9 | 300 | 25 |
| 4 | 4 | 3.9 | 300 | 25 |
| 5 | 1 | 4.2 | 800 | 15 |
| 6 | 8 | 4.2 | 800 | 15 |
| 7 | 9 | 4.2 | 800 | 15 |
| 8 | 10 | 4.2 | 800 | 15 |
| 9 | 11 | 4.2 | 800 | 15 |
| C1 | 1 | 0.1 | — | — |
| C2 | 1 | 10.9 | 50 | 27 |
| C3 | 5 | 3.9 | 300 | 25 |
| C4 | 6 | 3.9 | 300 | 25 |
| C5 | 7 | 3.9 | 300 | 25 |
| C6 | 12 | 4.2 | 800 | 15 |
| C7 | — | 5.4 | 150 | 39 |

TABLE 3

| | | | Crack | Abrasion- | Specular |
|---|---|---|---|---|---|
| Ex. | Writeability | Erasability | observation | Resistance | gloss |
| 1 | ◯ | ◯ | ◯ | ◯ | 19 |
| 2 | ◯ | ◯ | ◯ | ◯ | 19 |
| 3 | ◯ | ◯ | ◯ | ◯ | 19 |
| 4 | ◯ | ◯ | ◯ | ◯ | 19 |
| 5 | ◯ | ◯ | ◯ | ◯ | 28 |
| 6 | ◯ | ◯ | ◯ | ◯ | 27 |
| 7 | ◯ | ◯ | ◯ | ◯ | 27 |
| 8 | ◯ | ◯ | ◯ | ◯ | 27 |
| 9 | ◯ | ◯ | ◯ | ◯ | 27 |
| C1 | ◯ | ◯ | ◯ | ◯ | 93 |
| C2 | ◯ | X | ◯ | ◯ | 12 |
| C3 | ◯ | X | ◯ | ◯ | 19 |
| C4 | X | — | X | X | 19 |
| C5 | ◯ | X | X | X | 19 |
| C6 | ◯ | X | ◯ | ◯ | 27 |
| C7 | ◯ | X | — | X | 10 |

### Example 10

A white PET-G film having a thickness of 100 micrometers (from Achilles Co.) was laminated onto a 50 micrometers thickness of polyester film with release treatment (from Teijin DuPont Films Japan Limited) by heating. 100 mass parts of Hard-polymer 1 (See Table 4), 70 mass parts of Soft-polymer 1 (See Table 4), and 5 mass parts of Cross-linker 1 (See Table 4) with respect to 100 mass parts of Soft-polymer 1 (in solid) was added to give a polymer solution. Each polymer had a good compatibility with others. The white PET-G film was coated by the polymer solution with a knife coating, then dried and cured at 95° C. for 5 minutes, and formed a buffer layer of 5 micrometers thickness.

100 mass parts of SEIKABEAM P-1301 was added to 67 mass parts of DEFENSA FH-800ME, then diluted with MEK by double to give a solution. The solution was coated onto the buffer layer with a wire bar coating, then cured in a UV oven (from Fusion UV Systems, Inc.) and obtained a writing sheet precursor with a 5 micrometers thickness of the face layer.

The resultant face layer was embossed with the line speed of 10 mpm at 50° C. of emboss roll temperature and formed a surface unevenness with the following characteristics:

Arithmetic average roughness (Rₐ): 3.9 μm

Average ridge interval between adjacent protrusions (Sₘ): 300 μm

Maximum roughness depth (Rₜ): 25 μm

An acrylic adhesive (adhesive (BA/AA=90:10): Cross-linker 1=100:0.2 in solids) was coated on the double sided polyethylene laminated release liner (available from 3M) with knife coating so as to make the 40 micrometer thick adhesive after drying. Then, dried and crosslinked at 95° C. for 5 minutes to give an adhesive layer. The resultant writing sheet precursor was peeled the polyester film with release treatment off and laminated the PET-G film with the adhesive layer to give a writing sheet.

### Example 11

The sample was prepared in the same manner as Example 10 except that the thickness of the buffer layer was 21 μm.

### Example 12

The sample was prepared in the same manner as Example 10 except that the soft polymer was replaced with S2 (See Table 4).

### Example 13

The sample was prepared in the same manner as Example 10 except that the soft polymer was replaced with S3 (See Table 4) and the thickness of the buffer layer was 23 μm.

### Example 14

The sample was prepared in the same manner as Example 10 except that the soft polymer was replaced with S4 (See Table 4).

### Example 15

The sample was prepared in the same manner as Example 10 except that the soft polymer was replaced with S2 (See Table 4) and the thickness of the face layer was 3 micrometers

### Comparative Example C8

The sample was prepared in the same manner as Example 10 except that the sample had no buffer layer.

### Comparative Example C9

The sample was prepared in the same manner as Example 10 except that the thickness of the buffer layer was 10 μm.

### Comparative Example C10

The sample was prepared in the same manner as Example 13 except that the thickness of the buffer layer was 10 μm.

### Comparative Example C11

The sample was prepared in the same manner as Example 14 except that the thickness of the buffer layer was 9 μm.

TABLE 4

| | Monomer | | T_{g} | Solids | |
|---|---|---|---|---|---|
| | (Mass Ratio) | Mw | (° C.) | (%) | Solvent |
| Hard-polymer | MMA-BMA- | 70,000 | 66 | 40 | EtAc |
| 1 (H1) | DMAEMA | | | | |
| | (60:34:6) | | | | |
| Soft-polymer 1 | BA-AA | 760,000 | −48 | 33 | EtAc/ |
| (S1) | (94:6) | | | | toluene |
| Soft-polymer 2 | BA-AA | 630,000 | −44 | 33 | EtAc/ |
| (S2) | (90:10) | | | | toluene |
| Soft-polymer 3 | BA-2EHA-Vac- | 550,000 | −51 | 40 | EtAc/ |
| (S3) | AA | | | | toluene |
| | (40:47:8:5) | | | | |
| Soft-polymer 4 | BA-2EHA-AN- | 500,000 | −53 | 33 | EtAc |
| (S4) | AA | | | | |
| | (58:36:1:5) | | | | |
| Cross-linker 1 | E-5XM (available | — | — | 5 | MEK |
| | from Soken, | | | | |
| | epoxy) | | | | |

TABLE 5

| | | | | AA(COOH)/ | | |
|---|---|---|---|---|---|---|
| | | | Amount of | DMAEMA | | Buffer Layer |
| | Hard | Soft | soft-polymer | (NH₂) | | Thickness |
| Ex. | Polymer | Polymer | (mass parts) | Ratio* | Crosslinker | (μm) |
| 10 | H1 | S1 | 70 | 1.5 | 5.0 | 15 |
| 11 | H1 | S1 | 70 | 1.5 | 5.0 | 21 |
| 12 | H1 | S2 | 70 | 2.5 | 5.0 | 15 |
| 13 | H1 | S3 | 70 | 1.3 | 5.0 | 23 |
| 14 | H1 | S4 | 70 | 1.3 | 5.0 | 21 |
| 15 | H1 | S2 | 70 | 2.5 | 4.0 | 20 |
| C8 | None | None | None | 0 | None | 0 |
| 64656WO00 | H1 | S1 | 70 | 1.5 | 5.0 | 10 |
| C10 | H1 | S3 | 70 | 1.3 | 5.0 | 10 |
| C11 | H1 | S4 | 70 | 1.3 | 5.0 | 9 |

*equivalent ratio of carboxylic group and amino group in AA and DMAEMA respectively (mole ratio)

TABLE 6

| | | | Specular | | |
|---|---|---|---|---|---|
| | Pre-Heating | Post-Heating | Gloss | | |
| Ex. | Gloss | Gloss | Retention | Writeability | Erasability |
| 10 | 23 | 25 | Good | Good | Good |
| 11 | 18 | 20 | Good | Good | Good |
| 12 | 19 | 19 | Good | Good | Good |
| 13 | 18 | 23 | Fair | Good | Good |
| 14 | 18 | 25 | Fair | Good | Fair |
| 15 | 19 | 19 | Good | Good | Good |
| C8 | 19 | 32 | Poor | Good | Good |
| C9 | 16 | 28 | Poor | Good | Poor |
| C10 | 15 | 24 | Poor | Good | Poor |
| C11 | 15 | 25 | Poor | Good | Poor |

Although the present invention has been fully described in connection with the preferred embodiments thereof with reference to the accompanying drawing, it is to be noted that various changes and modifications are apparent to those skilled in the art. Such changes and modifications are to be understood as included within the scope of the present invention as defined by the appended claims unless they depart therefrom.

What is claimed is:

1. A communication article comprising a face layer on the front side of said article, said face layer having structured front surface and a base layer, wherein the face layer is a coating which comprises a resin consisting of a UV-curable oligomer having fluorine groups and/or comprises a UV-curable monomer having fluorine groups, and the resin has a fluorine content of about 0.02 mass % to about 0.1 mass % in a solid basis.

2. The article of claim 1 wherein the UV-curable oligomer having fluorine groups includes acrylic oligomer or acrylic urethane oligomer.

3. The article of claim 1 wherein said face layer has a thickness of from about 2 μm to about 20 μm.

4. The article of claim 1 wherein said structured surface was imparted to said face layer by embossing.

5. The article of claim 1 wherein said structured surface has from about 1 μm to about 5 μm of arithmetic average roughness (Rₐ).

6. The article of claim 1 wherein said structured surface has from about 200 μm to about 800 μm of average ridge interval between adjacent protrusions (Sₘ).

7. The article of claim 1 wherein said structured surface has from about 1 μm to about 30 μm of maximum roughness depth (Rₜ).

8. The article of claim 1 wherein said front surface of said face layer has about 30 or less of specular gloss.

9. The article of claim 1 further comprising a buffer layer between said face layer and said base.

10. The article of claim 9 wherein said buffer layer comprises a film forming resin comprising an amino group-containing (meth) acrylic polymer, a carboxylic group-containing (meth) acrylic polymer, and a cross-linker, one of the polymers has an average weight molecular weight of from about 40,000 to about 200,000 and a T_{g} of about 20° C. or more, and another has an average weight molecular weight of from about 400,000 to about 1,000,000 and a T_{g} of about 0° C. or less.

11. The article of claim 10 wherein the amount of the cross-linker is about 1 to 10 mass parts.

12. The article of claim 9 wherein said buffer layer has a thickness of from about 11 μm to about 100 μm.

13. The article of claim 1 further comprising an adhesive on the back side thereof.
